(19) United States
(12) Patent Application Publication
(10) Pub. No.: US 2011/0174951 A1
(43) Pub. Date: Jul. 21, 2011

(54) Hanger with an insulated hook

(76) Inventors: Frank Scott Sander, JR., North Las Vegas, NV (US); Daniel Scott Hagan, Pahrump, NV (US)

(21) Appl. No.: 12/657,460

(22) Filed: Jan. 20, 2010

(51) Int. Cl. F16L 3/24

(52) U.S. Cl. 248/339

(57) ABSTRACT

FIG. (1) and FIG. (2) show a top and bottom perspective of the device. Insulated Hook (12) is insulated and will be made of but not limited to, plastic, with a female screw receiving end adaptable to a standard piece of all-thread or install screw (14). Install screw ( )14 is a standard piece of all-thread cut to a desired length and will have hook (12) screwed on one end. The other end of install screw (14) will screw into hanger nut (16). Hanger nut (16) will be attached securely, for example by welding, to the bottom of body (18). The body (18) will envelope the adjust nut (20) and the adjust screw (22). Adjust screw (22) will be threaded into adjust nut (20) into and through the body (18). Body (18) will also house the toggle joint or pivot axle (24). Nose (28) will be attached to the body (18) by pivot axle (24). Wrapped around pivot axle (24) and anchored to the body (18) are the return springs (26a) and (26b). The return springs (26a) and (26b) will be pre-tensioned and attached also to the nose (28).

In an additional embodiment right nose (30) and left nose (32) are connected to center nose (28) by connector axle (34). This embodiment will stabilize and increase ease of install of the device.

FIGS. 1-9 are only examples of the possibilities of the hanger. And the device should not be limited to the above illustrated forms. Other applications and designs may become apparent as the above description, operation, and the drawings attached are studied by those in safety, manufacturing, construction, and related fields.

### CROSS-REFERENCE TO RELATED APPLICATIONS

Non-applicable

### FEDERALLY SPONSORED RESEARCH

Non-applicable

### SEQUENCE LISTING OR PROGRAM

Non-applicable

### BACKGROUND OF THE INVENTION

An improved mechanism for hanging temporary items from a variety of opposing surfaces.

### BACKGROUND

### Prior Art

Temporary power cords become damaged and unsafe when heavy construction traffic run them over. During construction, forklifts and hand trucks are constantly crossing the path of power cords that are used for lighting and for work. This is why OSHA requires the suspending of all power cords overhead. Currently, cords may be hung in three ways. The first is unsafe, the second is costly and sometimes unsafe, and the third is not adaptable to different types of surfaces.

The first method suspends temporary power cords from existing sprinkler pipes, plumbing, ductwork, or other equipment attached to the underside of the metal decking of each floor. According to OSHA, this is unsafe and against regulations because workers are constantly testing and continually working on this overhead equipment and pipes through all phases of the job. These pipes and equipment are made of conductive materials and a simple cut or nick in a live temporary power cord results in an electrical short or surge that hurts or kills those working on these overhead systems.

The second way partially solves the problem by dedicating hangers specifically for the temporary power cords. Home-made hooks or purchased hangers are attached for the power cords by drilling in a fastener from above before concrete is poured, or to the under side of the metal deck into the poured and cured concrete. For a hanger example, U.S. Pat. No. 5,228,256 by Ross Dreveny, 1993 Jul. 7, and U.S. Pat. No. 5,667,181 by Martin van Leewuen, 1997 Sep. 16, needs the device stabbed in before concrete is poured. Similarly, other pre-pour hangers are U.S. Pat. No. 6,634,151, 2003, Oct. 21 and U.S. Pat. No. 5,428,936, 1995 Jul. 4, both by Steven A. Roth, need a hole drilled into the metal.

There are hangers for the underside of metal decking after concrete has been poured and cured. U.S. Pat. No. 4,305,557 by Joseph W. Kowalski, 1981 Dec. 15, is a hanger example and is attached using concrete anchors after drilling a hole. U.S. Pat. No. 5,413,441 by David V. Heminger, 1995 May 9, is one example of a purchased anchor used for poured and cured concrete for attaching hangers. To anchor to the underside of the metal decking requires a hammer drill which uses a considerable amount of electricity. Even current cordless hammer drills can only drill a few holes per charged battery into metal decking and concrete. Therefore, generator, power cords, and at least two workers are needed for the install of the permanently anchored hangers. This alternative's disadvantage is that it involves constant drilling and re-drilling. Resulting in anchoring many hangers for temp power cords costing extra money in labor and time.

Partially solving hanging the cords safely are the use of plastic straps that are reusable and locking. U.S. Pat. No. 3,979,094 by Stuart DeWitt, 1976 Sep. 7 is an example. However, the disadvantage of current plastic strapping is that when the power cords get pulled on accidentally by forklifts they do not “give” and let go of the cords. The result is damage or destruction to the power cords. Also, it is common to use homemade anchors and hangers. For example, a 16 penny nail and a piece of wire driven into a drilled quarter inch hole for anchoring and a loop of wire for the hanger. Forklifts carrying loads high in the air often catch the power cords and put pressure and damage cords if the tie-wire hanger does not release the power cord. The disadvantages of permanent home-made or purchased anchors and hangers are the cost in labor and time to put them in a constantly changing location staying ahead of temporary power needs for lighting and work. Also, using tie-wire and or locking plastic straps are unsafe and cost extra money because they eventually destroy the power cords.

The third possibility of suspending power cords is by temporary metal deck hangers that require no drilling. A reusable device that relies on a certain shape of metal decking is made by ERICO International Corporation, copyright 2010. It is the Caddy OCDC Clip located on the internet under ERICO's PRODUCTS section. This clip requires an upturned overlap in the decking. Another decking hanger that can be installed with no drilling is U.S. Pat. No. 7,603,814 by Daniel L. Hartmann, 2009 Oct. 10. It uses a pinching motion to attach itself to metal decking. However, All of these temporary hangers will only fit on or into certain types and shapes of metal decking.

Some of the prior art used for suspending climbers from different sized crevices may be used for construction. Mountain climbing aids may be an alternative for hangers in specific shaped metal decking. Cam devices are now being made with a large enough range to possibly work for temporary power cord hangers. The Camalot #6, manufactured by Black Diamond is a temporary device that will work in a crevice up to 7 and 5/8 inches but costs at least 70 dollars per cam device. Information on The Camalot #6 can be found in the online Black Diamond catalog under Protection/Camalot. This cam device comes from a line of mountain climbing aids referring to U.S. Pat. No. 7,014,156 by Mikel Apezetxea, 2006 Mar. 21. The Camelot #6 is currently the largest of these cam devices on the market. The disadvantage of the above temporary hangers are they require specific shaped and spaced metal decking. Also, the climbing cams are very expensive.

Currently, temporary power cords may be hung in three ways. The disadvantages of the first way mentioned is unsafe, the second is costly and also unsafe, and the third is not adaptable to different types of metal decks and can be costly.

### (1) OBJECTS AND ADVANTAGES

Accordingly, several objects and advantages of our hanger are safety, speed, and adaptability to different shapes of metal decking.

Because our hanger is easy to install and move it will result in an increase in safety. Workers will not be tempted to hang cords from existing pipes and equipment whenever they need to quickly move to other areas. Our hanger, in the preferred and alternative embodiments, adjusts to different widths and may be installed into crevices of varying types of surfaces.

Also, workers will be safe from temp power cords hung from our screw-on insulated hooks. These hooks will not only insulate but also release the cords when “snagged” by passing forklifts. This releasing will leave cords undamaged and forklift driver simply puts cords back up on the hooks of our devices. Separating cords from all conductive materials will meet today's OSHA standards. And the ability of the insulated hooks to release cords will save on construction costs.

No drilling and easy adjustment of our hanger will increase the speed and adaptability at which cords are moved and then placed at different locations overhead.

### (2) OTHER OBJECTS AND ADVANTAGES

Other objects and advantages of our hanger are low cost and ease of production. Unlike the high cost climbing cam devices mentioned in the prior art our hanger's simple design will allow for a low cost per device.

Increasing awareness and rules of job-site safety will increase demand for this product. Our hanger will be required by OSHA in the future.

The device may also be produced in different lengths, shapes, and materials, for a variety of different surface and width applications.

It also is not difficult to learn how to use our hanger and will be used together with products, such as all-thread, already readily available on the market and at the job-site.

All-thread is common on all job-sites and is used for many overhead suspension applications. We use common all-thread in conjunction with our device further saving construction costs.

Systems are used to decrease construction costs. The assembly-line method is one example. In drawings FIG. 3, using a long piece of all-thread for the install screw 14, a worker could install many of the devices from the ground. The worker installing the device from the ground simply unscrews the long install screw 14 and uses it for installation of the next device moving down the length of the power cord. Like an assembly-line, another worker may be cutting enough all-thread, at a pre-determined length, for the entire line of install screws 14. Then the second worker will attach the assembled hook 12 and screw 14, to the body 18 of the devices overhead where the power cords will be placed for lighting or for work. This example of an assembly-line method using our hanger will save additional money. Requiring no power tools and or pre-planning the most inexperienced of workers will safely and timely install our hanger.

Again, the advantages are the low cost to make and sell our hanger. Demand will become high for the device because of an open market and OSHA requiring the use of the device in the future. Again, our hanger will also increase in safety, speed, and adaptability. Further objects and advantages of our hanger will become apparent from a consideration of the drawings and ensuing description.

### SUMMARY

A non-penetrating device for the insulated hanging of items that adjusts to lock itself between a variety of opposed surfaces.

### DRAWING DESCRIPTION

FIG. 1 is a perspective view, looking down on our hanger, showing the adjust screw 22 and hanger nut 20 enveloped in the body 18.

FIG. 2 is a perspective of the device from underneath, return springs 26a and 26b attached to pivot axle 24 can be seen.

FIG. 3 is a side perspective of the first step of installing the hanger.

FIG. 4 is a side perspective of the device, engaged but not locked, in channels of the opposed surfaces.

FIG. 5 is a side perspective of body 18 rotating on pivot axle 24 being pulled down past center to lock between opposed surfaces.

FIG. 6 is a top perspective of an alternative embodiment with a center nose 28, right nose 30 and left nose 32.

FIG. 7 is a bottom perspective showing center nose 28, right nose 30, and left nose 32

FIG. 8 is a perspective drawing of an alternate embodiment with padded non-marking pieces attached to each opposed nose 28 and adjust screw 22.

FIG. 9 is a perspective drawing of our hanger reduced into a “leaf-spring” type design, compromised of body 18 enveloping a slotted nose 28.

### DRAWINGS—LIST OF REFERENCE NUMERALS

12 Insulated Hook

14 Install screw

16 Hanger nut

18 Body

20 Adjust nut

22 Adjust screw

24 Pivot axle

26a Return spring

26b Return spring

28 Center nose

30 Right nose

32 Left nose

34 Connector axle

### DETAILED DESCRIPTION

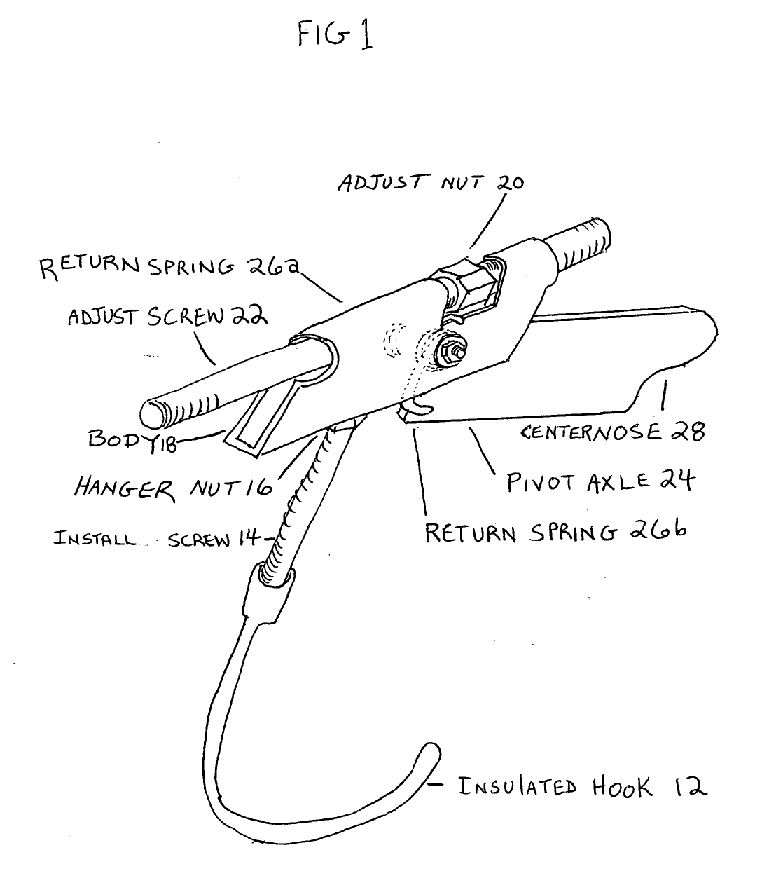

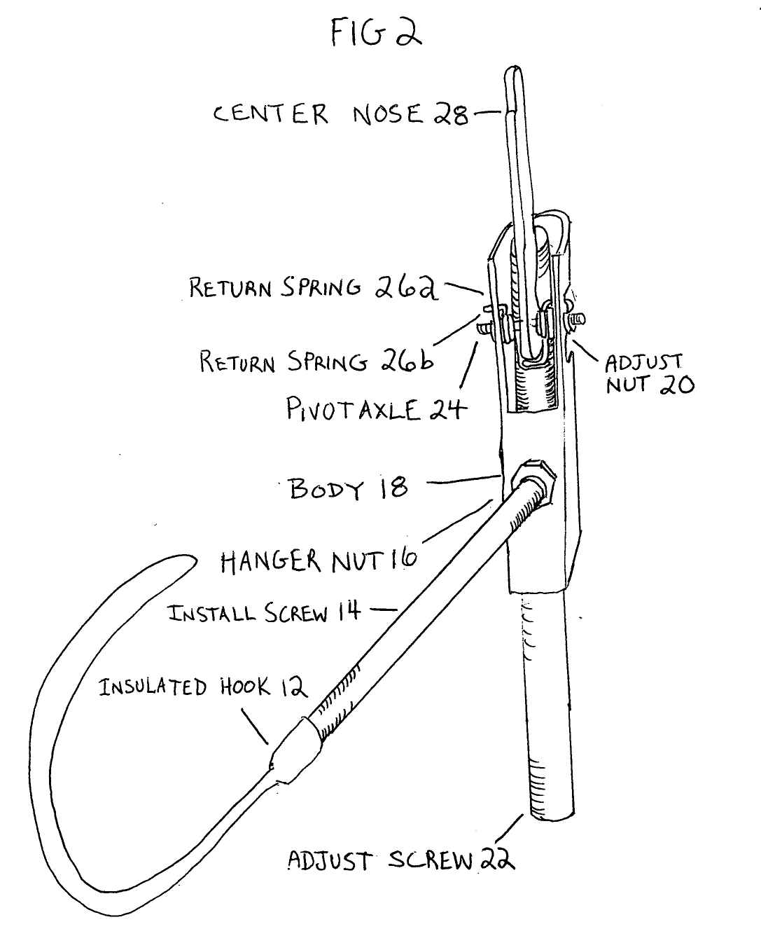

FIGS. 1 and 2 show a top and bottom perspective of the device. Insulated hook 12 is insulated and will be made of but not limited to, plastic, with a female screw receiving end adaptable to a standard piece of all-thread or install screw 14. Install screw 14 is a standard piece of all-thread cut to a desired length and will have hook 12 screwed on one end. The other end of install screw 14 will screw into hanger nut 16. Hanger nut 16 will be attached securely, for example by welding, to the bottom of body 18. The body 18 will envelope the adjust nut 20 and the adjust screw 22. Adjust screw 22 will be threaded into adjust nut 20 into and through the body 18. Body 18 will also house the toggle joint or pivot axle 24. Nose 28 will be attached to the body 18 by pivot axle 24. Wrapped around pivot axle 24 and anchored to the body 18 are the return springs 26a and 26b. The return springs 26a and 26b will be pre-tensioned and attached also to the nose 28.

### OPERATION OF INVENTION

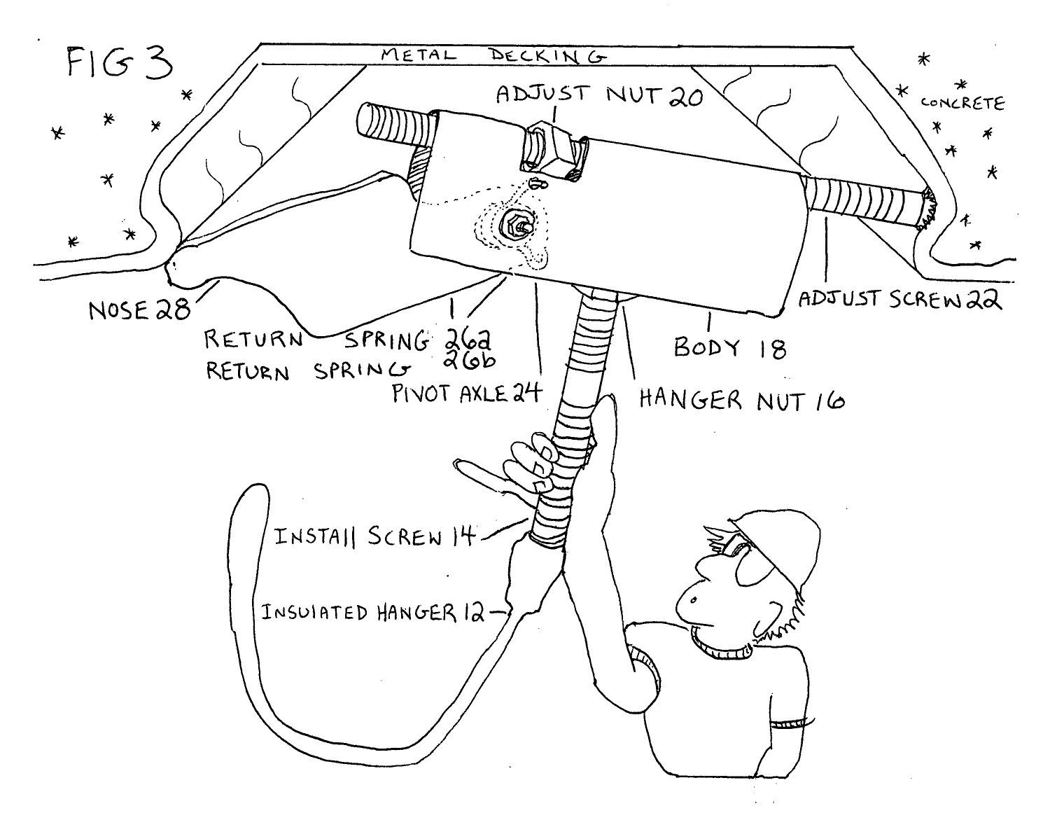

The operation of the preferred embodiment is shown in FIGS. 3, 4, and 5. Forklifts often “snag” or “catch” overhead temporary power cords with their top masts as they are carrying high loads. Hook 12 will allow a “snagged” cord to be pulled off because the cord is not locked into the device. Allowing the cord to safely “give way” and be pulled from the hanging devices. This will give the forklift driver time to stop without damaging the cords. The driver will be able to replace cords back up onto the “line” or series of the installed devices. Hook 12 is advantageous because of insulation and the damage-free ability of the cords to be pulled off of the installed devices by forklifts passing by with high loads. Also, if cords get pulled very hard, and the cord does not come off of hook 12, the threaded portion of 12 will strip under enough pressure. This increases construction speed because of threaded install of hook 12 and easy replacement of downed cords back onto still installed overhead devices. The install screw 14 is only a standard piece of all-thread common to all construction job-sites. Once install screw 14 is screwed into hanger nut 16 it becomes the handle that a worker uses to install and lock the device between opposing surfaces.

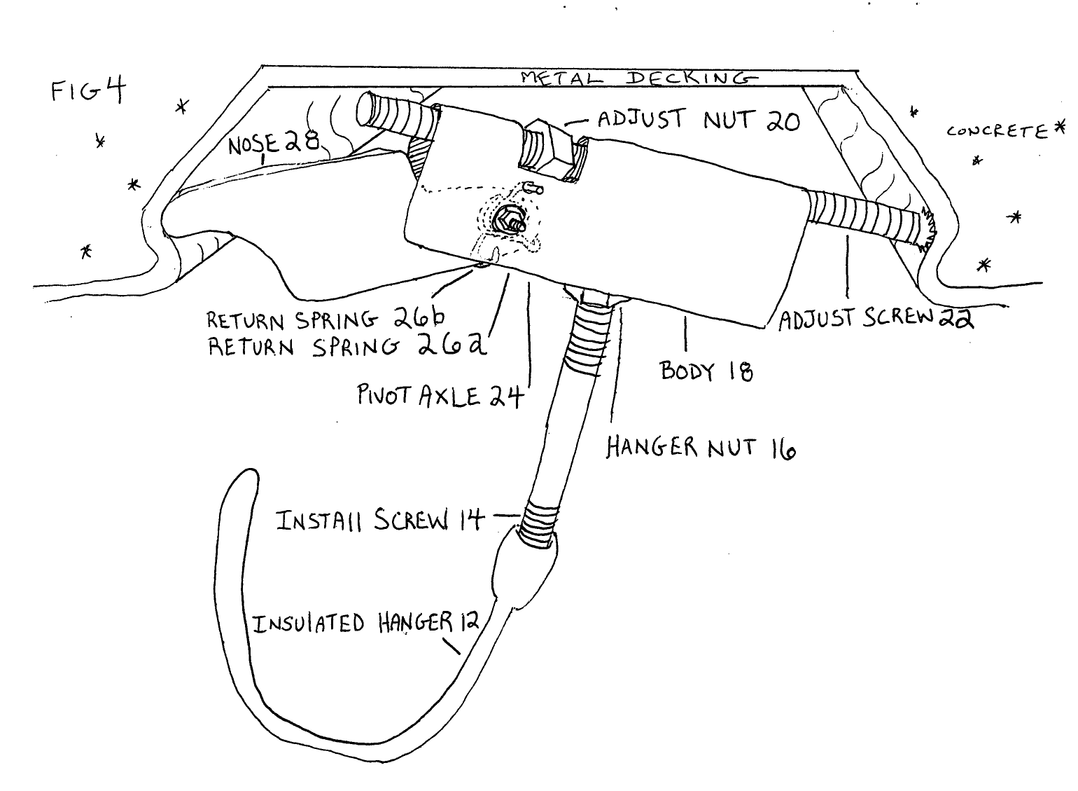

The worker, illustrated in FIG. 3, will adjust the device by moving the adjust screw 22 in or out through the adjust nut 20 that are both enveloped in the body 18. When the adjust screw 22 is at the correct length and with the return springs 26a and 26b providing constant opening pressure on nose 28 the worker can then position our hanger. Our device is then prepared for engagement which is illustrated in FIG. 4.

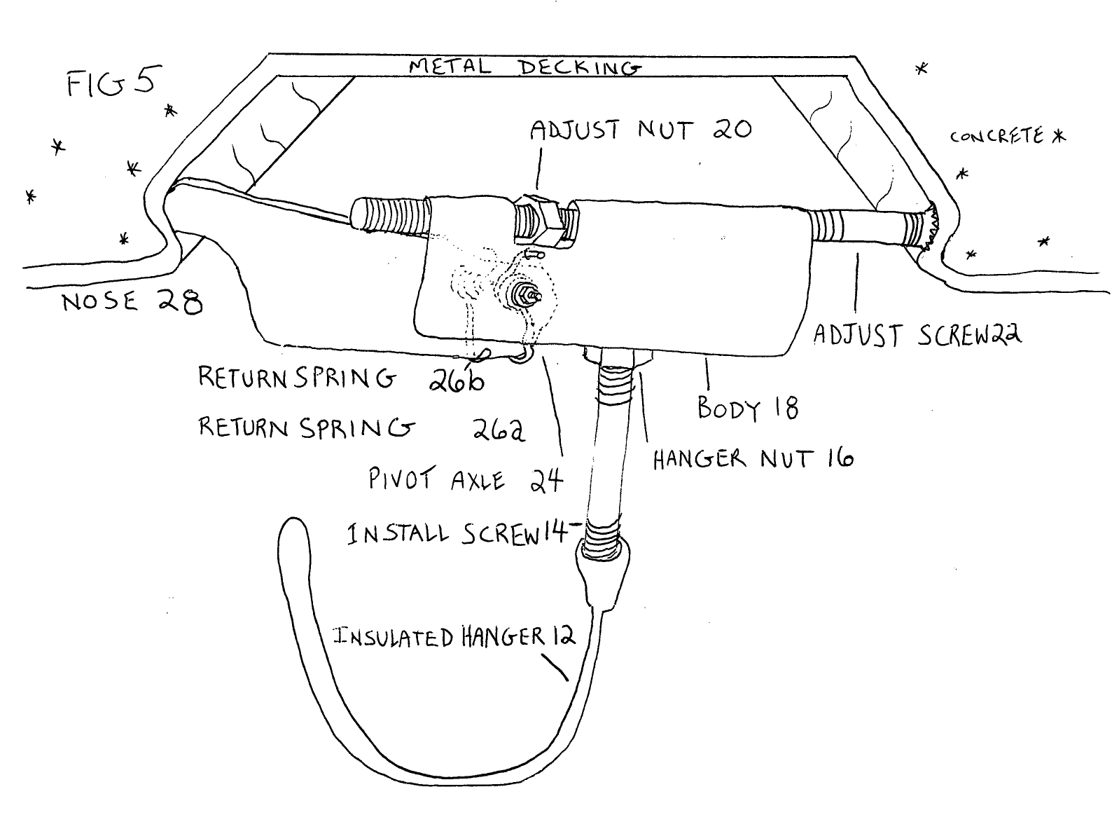

FIG. 5 shows the worker pulling downward past center on the device to lock it into place. The return springs 26a and 26b are applying an opening force on the nose 28 keeping the device engaged in the opposed surfaces. Nose 28 rotates downward into the locked position. Much force is produced as nose 28 rotates downward on pivot axle 24. The device lengthens as it becomes closer to horizontal creating the force necessary to remain safely installed. The nose 28 rotating down slightly past center and coming to a stop against the bottom of adjust screw 22 held inside of body 18 creates a locking effect.

### DESCRIPTION—ADDITIONAL EMBODIMENT

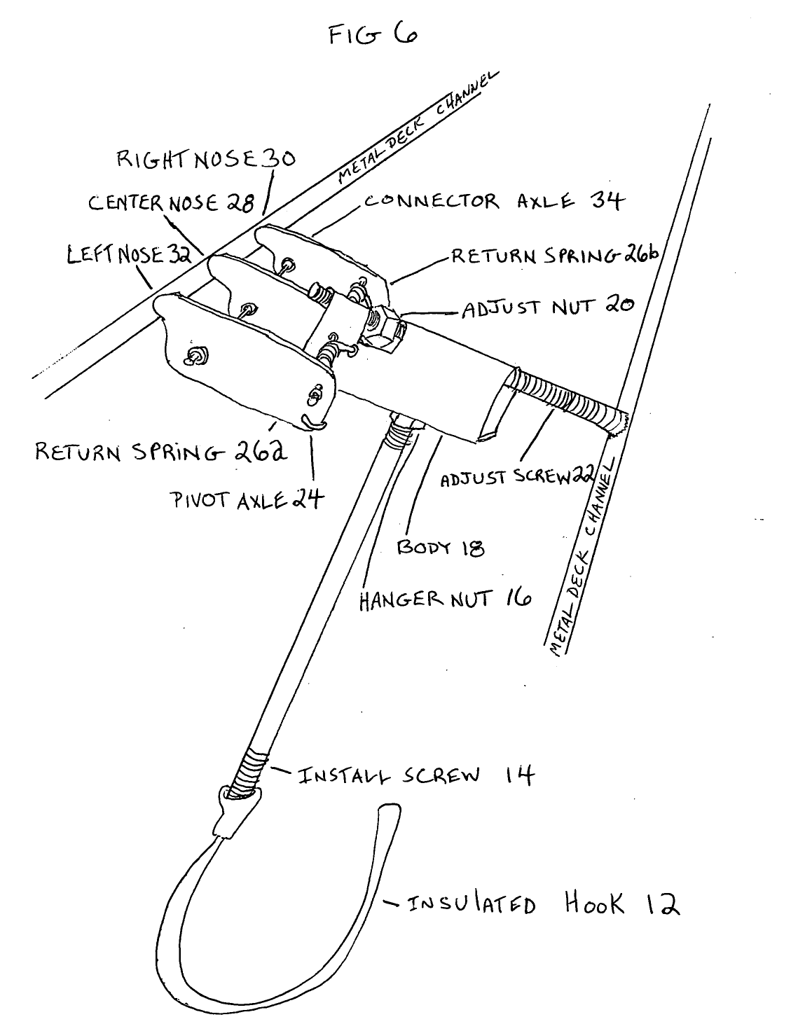

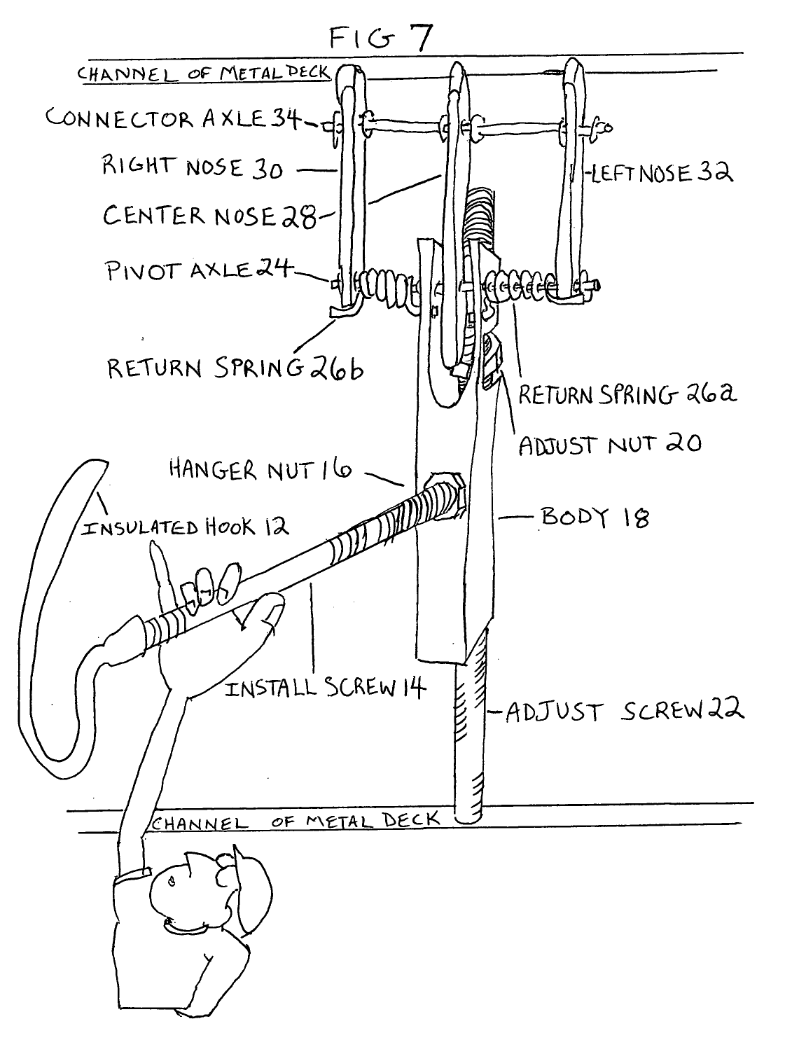

Shown in FIG. 6 and FIG. 7 this embodiment consists of added right nose 30 and left nose 32. Nose 30 and nose 32 are positioned on each side of nose 28. Attached to the body 18 through nose 28 by an extended pivot axle 24 and also attached at the front of nose 28, nose 30, and nose 32, by connector axle 34.

### OPERATION—ADDITIONAL EMBODIMENT

These axle to nose and body connections will be secure but with a slightly loose fit, providing side to side flexibility. FIG. 6 and FIG. 7 show an embodiment that stabilizes the opposing force contact when device is pulled on from either side. Forklifts carrying loads high in the air cross the path of power cords. As mentioned, the forklifts will often snag the power cords and apply a pulling force on the overhead hangers holding the power cords. In this embodiment the nose pieces 28, 30, and 32 are loosely attached to body 18 by pivot axle 24 and connector axle 34. The loose attachment allows for flexible side to side movement while still being locked past center and stable against the opposed surfaces. This flexibility may provide a more stable hanger when cords and the installed devices are being pulled on from the side. Ease of install will be increased in that the return springs 26a and 26b are even larger and stronger in FIG. 7 and placed out and on each side of body 18. The stronger the tension pushing outward the better the device will engage as shown in FIG. 4. Also, the three noses 28, 30, and 32 will allow installer to better align the device perpendicular to the opposed surface. The better the perpendicular alignment the more secure the installation of our device.

### DESCRIPTION AND OPERATION—ADDITIONAL EMBODIMENT

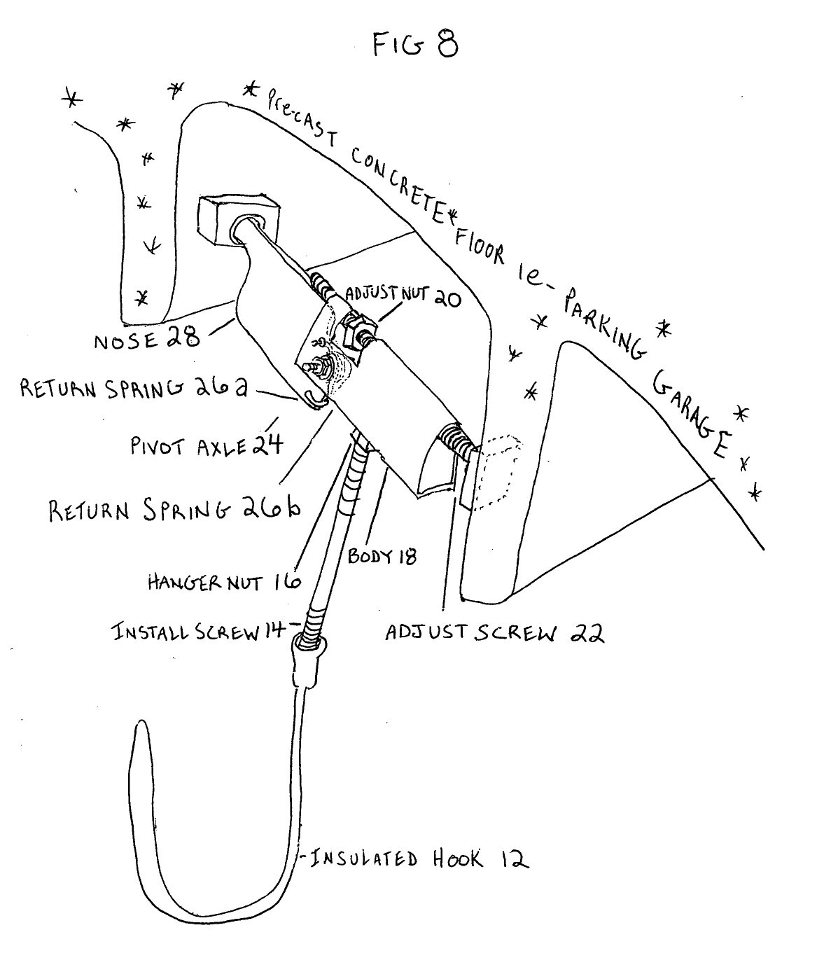

FIG. 8 shows padded non-marking tips on the adjust screw 22 and nose 28 for install on opposing surfaces installer does want damaged. Nose 28 and adjust screw may have different surfaced tips added, for example and not limited to, teeth for gripping surfaces like wood. This alternative will not need “channels” or indented areas in the opposing surfaces. Acting against gravity with the lengthening and outward force the device creates in its locked position.

### DESCRIPTION AND OPERATION—ADDITIONAL EMBODIMENTS

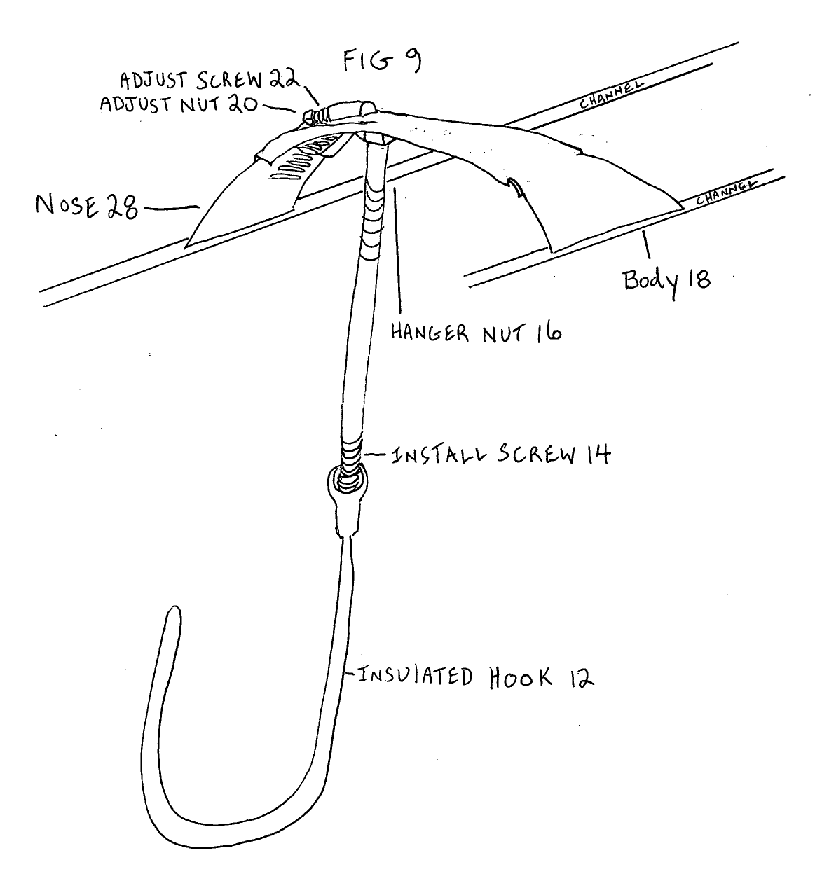

FIG. 9 shows the hanger in a slightly different, and not limited to, shape of a “leaf-spring” taking the place of the pivot axle 24 and return springs 26a and 26b tendency of pushing open toward horizontal. In this embodiment the device will start with body 18 and nose 28 together in the horizontal position As with the preferred embodiment, the installer will find the correct length with an in and out motion of the slotted nose 28 and body 18. Using adjust nut 20 and adjust screw 22 together as one, like the operation of a simple “hose clamp”, the nose 28 may move in or out of body 18. At the found length of combined nose 28 and body 18 the installer using install screw 14 tight into hanger nut 16 will push device up and between the opposed surfaces. When this embodiment is installed it will be arched under tension against the opposed surfaces and locking itself in position.

### CONCLUSION, RAMIFICATIONS, AND SCOPE

The above described is a non-penetrating device for the insulated hanging of items that adjusts to lock itself between a variety of opposed surfaces. Several objects and advantages of our hanger are safety, speed, and adaptability to different shapes of opposed surfaces.

Other objects and advantages of our hanger are low cost and ease of production. The device may also be produced in different lengths, shapes, and materials, for a variety of different surface and width applications.

It also is not difficult to learn how to use our hanger and may be used together with products, such as all-thread, readily available on the market and at the job-site.

Increasing awareness and rules of job-site safety will increase demand for this product. This type of hanger will be required by OSHA in the future.

FIGS. 1-9 are only examples of the possibilities of the hanger. And the device should not be limited to the above illustrated forms. Other applications and designs may become apparent as the above description, operation, and the drawings attached are studied by those in safety, manufacturing, construction, and related fields.

1-3. (canceled)

4. A hanger comprising of a pivoting nose section and an adjusting screw that are both enveloped in a body whereby a user may hang a variety of items from various widths and types of opposed surfaces.

5. The hanger of claim 4 means of adjusting to different widths consisting of a screw and nut assembly sandwiched in said body.

6. The hanger of claim 4 consisting of a body housing the pivoting axle connecting the nose toward the horizontal or “open” position and connector axle stabilizing said nose.

7. The hanger of claim 4 consisting of contact points to opposed surfaces being nose and adjust screw urged “open” by return springs at the pivot axle in said body.

8. The hanger of claim 4 when adjusted correctly will self-lock by pulling down and pivoting past center said nose, stopping against opposed said adjust screw sandwiched in said body.

9. The hanger of claim 4 consisting of a screw-on insulated means of hanging items, whereby said hanger will be non-penetrating and self-locking between opposed surfaces.
